(19) United States
(12) Patent Application Publication
(10) Pub. No.: US 2005/0224151 A1
(43) Pub. Date: Oct. 13, 2005

(54) Mold and tread made therein

(75) Inventors: Eric de Benedittis, Saint-Beauzire (FR); Gilbert Menard, Volvic (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 11/093,044

(22) Filed: Mar. 30, 2005

Related U.S. Application Data
(60) Provisional application No. 60/586,874, filed on Jul. 12, 2004.

(30) Foreign Application Priority Data
Apr. 13, 2004 (FR) 04/03907

(51) Int. Cl. B29C 35/02; B60C 11/00; B60C 11/01

(52) U.S. Cl. 152/209.16; 425/35; 425/37; 152/209.17

(57) ABSTRACT

Mold for molding a tread that comprises a running surface, lateral faces and at least one axial cavity opening onto at least one lateral face. The cavity is molded with the aid of a pin which, during molding, produces two rubber mix flows that envelop the pin and reunite to form a junction surface, such that the mean length of the trace of this junction surface in a section plane perpendicular to the mold face that molds the running surface and to the axial direction, is larger than the minimum distance between the cavity and the mold face that molds the running surface.

### FIELD OF THE INVENTION

The present invention concerns molds and treads for tires. In particular it concerns molds that enable the molding of treads having cavities at least part of which is located below the running surface and which open onto at least one lateral face of the tread.

### DEFINITIONS

In this document the terms “axial” and “axially” refer to a direction essentially parallel to the rotation axis of a tire. When these terms are applied to a tread, they refer to the direction parallel to the rotation axis of the tire once the tread is fixed on the tire. In other words, the axial direction is the direction perpendicular both to the thickness of the tread and to the circumference of the tire.

The terms “radial” and “radially” refer to a direction parallel to a vector perpendicular to the axial direction and which intersects the rotation axis of a tire. When these terms are applied to a tread they refer to the directions parallel to a vector perpendicular to the tire's rotation axis, and comprising a point on the tire's rotation axis once the tread is incorporated on the tire. In other words, a radial direction is a direction parallel to the thickness of the tread.

“Running surface” of a tread is understood to mean the surface formed by the points of the tread that come into contact with the ground when the tire is rolling.

“Lateral face” of a tread means any part of the surface of the tread which extends from the axial ends of the running surface to the sidewalls of the tire. When considering a tread before it has been incorporated on a tire, a lateral face consists of the part of the tread's surface that connects one of the axial edges of the running surface to the surface designed to come into contact with the carcass of the tire.

“Pin” is understood to mean any molding element designed to mold a cavity at least part of which is located below the mold face that molds the running surface and which opens onto at least one lateral face of the tread, without any limitation of its geometry.

“Longitudinal axis” of a pin means an axis essentially parallel to the direction in which the dimension of the pin is greatest.

“Mix” or “rubber mix” means a rubber composition containing at least one elastomer and filler.

“Flow” of a mix means the flowing of a quantity of the mix during molding.

“Flow asymmetry” produced during the molding of a cavity, is understood to mean the asymmetry in the flow velocity field between the parts of the mix that surround the pin molding the cavity on either side of the surface perpendicular to the surface of the mold that molds the running surface and comprising the points of the pin located furthest away from the mold face that molds the running surface, as described later.

Here, the term “tire” denotes any type of elastic casing, whether inflated or not and whether or not subjected to an internal pressure during use.

### BACKGROUND

The presence of cavities located under a tire's running surface and opening onto at least one lateral face of the tread confers advantageous properties on the tire, particularly when the maximum thickness of its tread exceeds 15 mm. The cavities contribute towards cooling the shoulders of the tire (by a ventilation effect) and consequently improve its endurance. They also render the pattern of the tread evolutional since they emerge at the tread surface as the wear of the tread progresses, so favoring grip on wet ground, snow and ice.

Molds that enable the molding of treads provided with such cavities have been long known. Two approaches can be distinguished: either mobile pins are caused to penetrate into the uncured rubber mix, or the mix that is to form the tread is made to flow and so envelop the pins during molding.

U.S. Pat. No. 1,604,450 is an example of the first approach: it describes the use of movable pins which penetrate axially into a lateral face of the tread after the uncured tire has been placed in the mold and before the vulcanization of the tire. The pins must penetrate without being deformed but also without displacing, nor deforming the uncured tire, and this imposes constraints in terms of the geometry and thickness (mechanical strength) of the pins.

The molds corresponding to the second approach enable cavities to be molded without moving the pins during the molding phase. U.S. Pat. No. 6,408,910 describes a mold whose pins are permanently attached to the shells provided for molding the sidewalls of a tire. During molding, the internal pressure in the uncured—and therefore plastically deformable—tire exerted by the membrane increases the outer diameter of the uncured tire. This stage, known as “shaping”, forces the material constituting the tread to fill up all the spaces in the mold so as to produce the final tread comprising the cavities. To extract the tire from the mold, the shells are moved apart axially to enable the pins to be extracted from the tread. This process has a drawback: it can only be used for fabrications in which the shaping phase is relatively pronounced, since it must correspond at least to the thickness of the pattern desired, including the cavities under the running surface.

Now, the trend in the industry is to try to limit the extent of shaping as much as possible. That is the reason why patent application EP 1 232 852 shows another type of mold, which corresponds to the first approach. The mold proposed comprises a series of crown sectors designed to mold radial cavities or grooves, and a series of shoulder sectors comprising pins designed to mold the axial cavities, both series of sectors being able to move radially. The arrangement of the pins on movable sectors enables the diameter of the circle, on which the pins are arranged, to be increased before the uncured casing is put in place, making it possible to reduce the shapeability of the casing. It is proposed that during the phase of radial penetration into the mix, the pins should be in contact with the crown sectors so as to resist the pressure exerted on the pins by the material that is to be molded. Thus it becomes possible to use relatively long and thin pins, which are susceptible to bending under the pressure exerted by the uncured mix.

Both approaches have proved effective in use; however, treads made in this way can have undesirable properties. In effect, whichever approach is chosen: radial penetration of the pins or radial flow of the mix, the formation of the final tread entails a flow of the mix either side of the pin with the formation of a junction plane that extends between the surface of the pin and the mold face that molds the tire's tread. The use of molds corresponding to the present state of the art creates a junction plane perpendicular to that surface, which can prove fragile, in particular because of its sensitivity to contamination during the molding.

### SUMMARY OF THE INVENTION

One objective of the present invention is to control the position of the junction zone and its orientation relative to the surface of the tire. It is proposed to do this by means of a mold for molding a tread made of rubber mix, this tread having a running surface that is bounded axially by lateral faces, the mold comprising at least one part for molding the running surface, at least two lateral parts for molding the lateral faces, and at least one pin for molding a cavity within the tread, the pin, viewed in a section plane perpendicular to the surface that molds the running surface and to the axial direction, having a surface with a contour formed of a first contour portion and a second contour portion, these contour portions extending between the point of the contour closest to and the point of the contour furthest from the surface that molds the running surface, the pin being located at least partially below the surface that molds the running surface and being connected to at least one surface that molds at least part of a lateral face of the tread, such that during molding the pin creates two flows of rubber mix which envelop the pin and reunite to form a junction surface, wherein at least one pin has means for rendering the mix flows asymmetrical so that the junction surface, viewed in the said plane, is such that the length of the trace of the junction surface on the plane, measured between the surface of the pin and the surface that molds the running surface, is larger than the minimum distance between the surface of the pin and the surface that molds the running surface.

When several points of the contour are at the same maximum distance from the mold face that molds the running surface, the two points furthest away in a direction perpendicular to the radial direction and to the axial direction are used. The two contour portions extend between each of these two points and the contour point located closest to the surface that molds the running surface. An analogous procedure is used if several contour points have the same minimum distance relative to the mold face that molds the running surface. As an example, for a pin whose surface, in a section plane perpendicular to the mold face that molds the running surface and to the axial direction, is a rectangle whose lengths are parallel to the mold face that molds the running surface and whose widths are perpendicular to that mold surface, the two contour portions coincide with the widths of the rectangle.

The mold of the invention makes it possible to enlarge the junction surface which extends between the surface of the cavity and the mold face that molds the running surface, whatever the degree of shaping; the means proposed, can be implemented in molds with or without shaping.

Several means can be used to obtain asymmetrical flows. In particular a pin geometry can be chosen which can produce asymmetrical mix flows during the penetration of the pin or, in the case of shaping, during the flow of mix around the pin.

In a preferred embodiment, the flows are made asymmetrical by using pins whose first and second contour portions have different length. Preferably, the difference between the lengths of the first and second contour portions is at least equal to 10% of the length of the shorter contour portion.

In another preferred embodiment, the mix flows around a pin are rendered asymmetrical by providing one of the contour portions with a mean roughness greater than the mean roughness of the other contour portion. For example, the roughness of the first portion can be increased by sand-blasting and the roughness of the second portion reduced by polishing. Preferably, the difference between the mean roughnesses Ra of the first and second contour portions is at least equal to 2 microns. Of course, it is possible to combine the effects of geometry and surface roughness by using pins whose first and second portions have both lengths and roughnesses that are different.

In a third preferred embodiment, the flows are made asymmetrical by a chemical coating applied to at least part of at least one of the contour portions so as to produce a difference in the slip velocity of the rubber mix on the portions. For example, the first contour portion can be coated with Araldite® and the second made of steel. The effects of coating and of geometry and/or roughness are advantageously combined by using pins whose first and second portions have both coatings, and lengths and/or roughnesses that are different.

In a fourth preferred embodiment, the mix flows are made asymmetrical by a temperature effect, by producing a mean temperature difference between the surfaces that correspond to the first and second contour portions of each pin. Preferably, the temperature difference is at least 20° C. There is no reason not to combine the effects of temperature and geometry and/or roughness and/or coating of the pin to make asymmetric of the mix flows around each pin in an optimum way.

In a fifth preferred embodiment, at least one pin for molding a cavity has additional means for causing it to rotate essentially about its longitudinal axis. This rotation can be carried out during the penetration of the pin into the mix (if the pins are mobile), during the shaping phase (if there is one) and/or when the pin is surrounded by mix, before the vulcanization of the tread.

All the embodiments described above are applicable in molds with or without shaping. A last preferred embodiment concerns more particularly molds without shaping whose mobile pins penetrate into the mix forming the tread after the tire blank or the tread has been inserted into the mold. In this preferred embodiment at least one pin, preferably of cylindrical geometry, is mounted so as to be both axially and radially mobile relative to the mold, so that it can carry out a translation movement in a plane forming an angle smaller than 90° with a radial direction. The mix flows around the pin during its penetration into the mix reunite after the pin has passed and form a junction surface which is inclined relative to a plane perpendicular to the mold face that molds the running surface. Consequently, the mean length of the trace of the junction surface on the this plane, measured between the surface of the pin and the mold face that molds the running surface, is larger than the minimum distance between that pin and the mold face that molds the running surface. It is possible to combine the effect of penetration along a direction forming an angle smaller than 90° relative to a direction perpendicular to the molding surface, with the effects of temperature and/or geometry and/or roughness and/or coating and/or rotation of the pin essentially about its longitudinal axis, to enlarge the junction surface extending between the surface of the pin and the mold face that molds the running surface.

The invention also concerns a tread made of rubber mix, this tread having a running surface bounded axially by lateral faces and comprising at least one cavity at least part of which is located below the running surface and which opens onto at least one lateral face of the tread, the tread being provided with a junction surface that extends between the surface of at least one cavity and the running surface, wherein the length of the trace of the junction surface in a section plane perpendicular to the running surface and to the axial direction, measured between the cavity and the running surface, is longer than the minimum distance between the surface of the cavity and the running surface. Preferably, the difference between the length of the trace and the minimum distance between the surface of the cavity and the running surface is greater than 20% of the minimum distance.

The invention will be better understood thanks to the description of the drawings, in which:

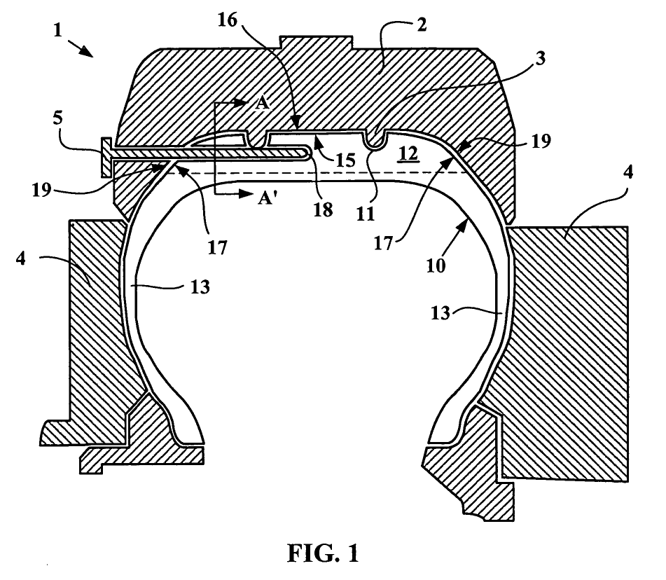

FIG. 1 shows a schematic axial section of part of a mold in its closed configuration and the corresponding part of a tire molded in this mold.

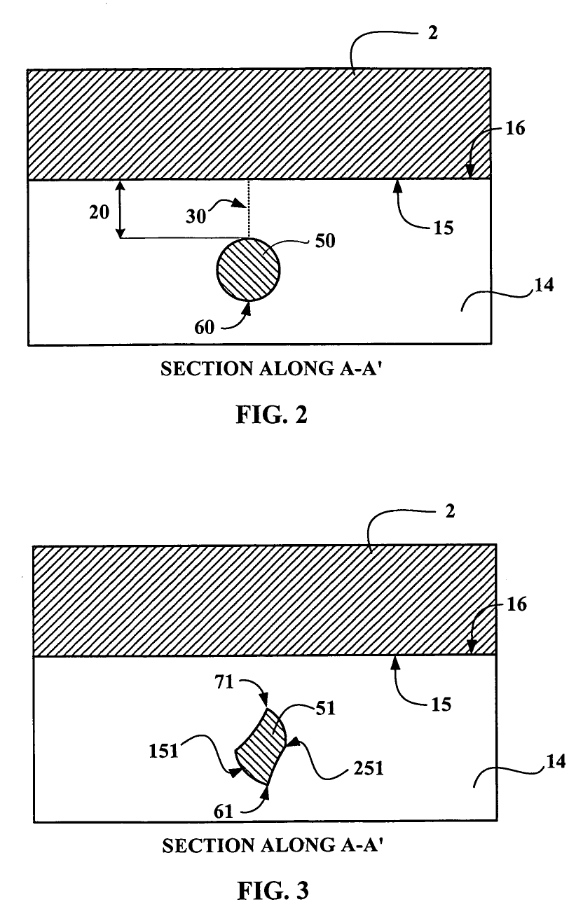

FIG. 2 shows a schematic radial section AA′ of the mold in FIG. 1, fitted with a pin of the prior art.

FIG. 3 shows a schematic radial section AA′ of the mold in FIG. 1, fitted with a pin according to the invention and illustrating the concept of a “contour portion”.

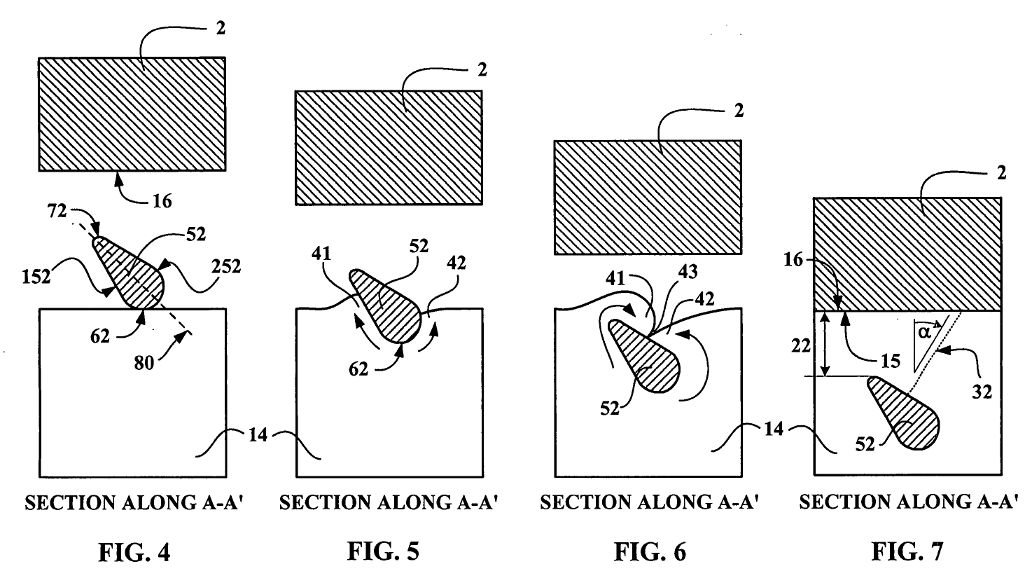

FIGS. 4 to 7 are schematic representations, in a radial section plane AA′ of the mold of FIG. 1, of the penetration of a pin according to the invention into the mix constituting the tread.

FIGS. 8 to 11 are schematic representations of variants of pins according to the invention, viewed in section.

### DESCRIPTION OF EMBODIMENTS

FIG. 1 shows a mold 1 according to the invention in its closed configuration. The representation is schematic: in particular, only the parts of the mold 1 involved in molding have been represented; the reinforcing parts have been omitted for the sake of clarity. For a better understanding of the functions of the elements described, a corresponding portion of a tire 10 obtained with the mold 1 is also shown. In this partial sectional view along a plane containing the rotation axis of the tire a crown sector 2 can be seen, which has a relief 3 to mold a cavity or groove 11 of a tread 12 of the tire 10. This crown sector 2 can move radially relative to shells 4 that mold the sidewalls 13 of the tire 10 in a manner already known as such. The crown sector 2 has a pin 5 designed to form a cavity 18 that extends axially below the running surface and opens onto a lateral face 17 of the tread 12. This pin 5 can move axially so as to allow the extraction of the tire from the mold.

FIG. 2 shows schematically a radial section AA′ of the mold 1 in FIG. 1, provided with a pin 50 of the prior art. This pin 50 is surrounded by the mix 14 constituting the tread 12. A part of the crown sector 2 can also be seen. The running surface 15 is located at the interface between the tread 12 and the crown sector 2.

The pin 50 of the prior art does not produce asymmetrical mix flows during the molding of the cavity 18: the velocity fields characterizing the flow of the mix are symmetrical with respect to the axis perpendicular to the mold face 16 that molds the running surface 15 and passing through the point 60 of the pin located furthest away from that face. Consequently, the junction surface 30 formed between the parts of the mix that have flowed round the pin 50 during molding is essentially perpendicular to the mold face 16 that molds the running surface 15. Its length is essentially equal to the minimum distance 20 separating the surface of the pin 50 from the face 16.

FIG. 3 shows a schematic cross-section AA′ of the mold 1 of FIG. 1, fitted with a pin 51 according to the invention. This pin 51 illustrates the concept of a “contour portion”. In the section plane chosen, it is easy to see the point 61 of the contour of the pin 51 which is furthest away from the mold face 16 that molds the running surface 15 and the point 71 of the contour of the pin 51 which is closest to that face, as well as the two contour portions 151 and 251 that connect those points. In this case the difference in length between the first and second contour portions is equal to 20% of the length of the portion 251.

FIGS. 4 to 7 are schematic representations, in a section plane AA′ of the mold 1 of FIG. 1, showing the penetration of a pin 52 according to the invention into the mix 14 constituting the tread 12. The sequence is valid for molds with shaping (when the mix 14 is in motion and envelops the pin 52) or without shaping (in which case it is the pin 52 which is in motion and penetrates into the mix 14).

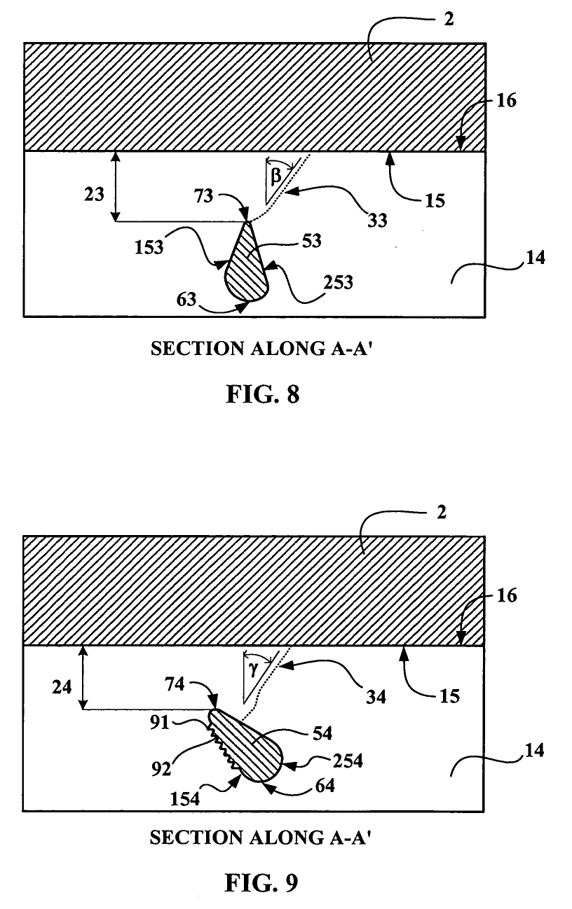

FIG. 4 shows a radial section AA′ of the mold 1 at the moment when the pin 52 comes in contact with the mix 14 constituting the tread 12. This contact occurs at the point 62 of the pin 52 furthest away from the mold face 16 that molds the running surface 15 (FIG. 7).

FIG. 5 shows the same radial section AA′ of the mold 1 a few moments later. The point 62 of the pin 52 has penetrated into the mix 14, so producing two mix flows 41 and 42. It can be seen that the geometry of the pin 52 generates asymmetrical flows: the part 41 of the mix approaches the face 16 more quickly than the part 42 of the mix flowing round the pin 52 on the other side. It will be noted that the flows are rendered asymmetrical by a pin having an axis of symmetry 80 (broken line in FIG. 4) but one which is inclined relative to the direction perpendicular to the mold face 16. For the inclination chosen, the difference between the lengths of the contour portions 152 and 252 is 10% of the length of portion 152. If the same pin 52 had been mounted in the mold so that the axis 80 was perpendicular to the surface 16, the portions 152 and 252 would be of equal length and the pin would not render asymmetrical the mix flows 41 and 42 passing around it.

FIG. 6 shows the same section AA′ of the mold 1 at the instant when the mix flows 41 and 42 reunite after having passed around the pin 52. The point of reunion 43 which constitutes the initiation point of the junction surface 32 (FIG. 7) does not coincide with the point 72 (FIG. 4) closest to the mold face 16.

FIG. 7 shows the same section AA′ of the mold 1 when the pin 52 has finished penetrating into the mix 14 constituting the tread 12. The mix 14 has enveloped the pin 52 and filled up the space between the pin 52 and the face 16 that molds the running surface 15. The parts 41 and 42 of the mix that have flowed around the pin 52 have reunited to form a junction surface 32 that extends from the surface of the pin 52 to the surface 16 that molds the running surface 15. The fact that the flows were asymmetrical generates an inclination ( [symbol] ) of the junction surface 32. The length of the trace of this surface 32 on the section plane, measured between the surface of the pin 52 and the mold face 16, is larger than the minimum distance 22 separating the surface of the pin 52 from the face 16.

FIG. 8 shows schematically a radial section AA′ of the mold 1 of FIG. 1, fitted with another pin 53 according to the invention. The flows are rendered asymmetrical by a particular geometry of the pin 53, which has no symmetry axis in the section plane chosen. The difference in the lengths of the contour portions 153 and 253 connecting the points furthest away 63 and closest to 73 the mold face 16 that molds the running surface 15, is equal to 10% of the length of portion 253. The fact that the flows are asymmetrical generates an inclination ( [symbol] ) of the junction surface 33 formed between the mix parts that have flowed past the pin 53 during molding. The trace length of this surface 33 on the section plane, measured between the surface of the pin 53 and the mold face 16 that molds the running surface 15, is longer than the minimum distance 23 separating the surface of the pin 53 from the face 16 that molds the running surface 15.

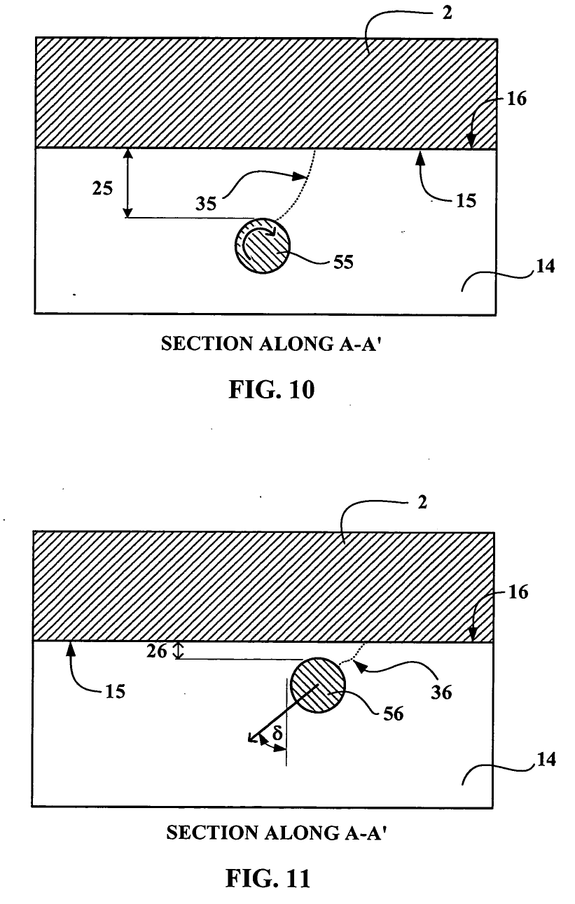

FIG. 9 shows schematically a radial section AA′ of the mold 1 of FIG. 1, fitted with a fourth pin 54 according to the invention. As in the previous case, the mix flows are rendered asymmetrical by the geometry of the pin 54. This pin has a geometry close to that of the pin 52, with the difference that one of the contour portions is provided with axial ridges 91 and grooves 92 arranged parallel to one another at 3 mm intervals and having a triangular profile 2 mm high. The difference between the contour portions 154 and 254 connecting the points furthest from 64 and closest to 74 the mold face 16 that molds the running surface 15 is equal to 10% of the length of portion 154. The fact that the flows are asymmetrical generates a mean inclination ( [symbol] ) of the junction surface 34 formed between the parts of the mix that have flowed past the pin 54 during molding. The trace length of this surface 34 on the section plane, measured between the surface of the pin 54 and the mold face 16 that molds the running surface 15, is longer than the minimum distance 24 separating the surface of the pin 54 from the face 16 that molds the running surface 15.

FIG. 10 shows schematically the radial section AA′ of the mold 1 of FIG. 1, fitted with a fifth pin 55 according to the invention. In contrast to the examples described above, here the mix flows are rendered asymmetrical not by the geometry of the pin 55 but by rotating the latter during molding. This rotation causes the velocity field to become asymmetrical: the mix flowing past the pin is either accelerated or braked in its movement by the rotary motion of the pin 55. Consequently, the junction surface 35 formed between the mix parts that have flowed past the pin 55 during molding is inclined. The trace length of this surface 35 on the section plane, measured between the surface of the pin 55 and the mold face 16 that molds the running surface 15, is longer than the minimum distance 25 separating the surface of the pin 55 from the face 16 that molds the running surface 15.

FIG. 11 shows schematically the radial section AA′ of the mold 1 of FIG. 1, fitted with a pin 56 according to the invention which is mounted so that it can move axially and radially relative to the mold 1 in a direction that forms an angle ( [symbol] ) with a radial direction. The direction of the pin's translation movement is indicated by an arrow. The mix flows passing on either side of the cylindrical pin during its penetration into the mix reunite once the pin has passed and form a junction surface 36 which is inclined relative to a plane perpendicular to the mold face 16 that molds the running surface 15. At all times the length of the trace of this junction surface 36 in the section plane is longer than the minimum distance 26 separating the surface of the pin 56 from the face 16.

Satisfactory results are obtained when the mix flows are made asymmetrical over almost the whole of the pin, possibly except at the ends of the pin.

Whereas FIG. 1 shows a pin 5 which molds a cavity 18 extending from one lateral face 17 of the tread 12 of the tire 10 as far as half the width of the tread, it will be understood that the cavity 18 can extend beyond the middle of the tread. Shorter cavities can also be envisaged.

Likewise, it is understood that the principle of the invention can be applied regardless of whether it is desired to mold cavities on only one lateral face of the tread or on both lateral faces. The cavities on opposite sides can be arranged symmetrically or not. The crown sectors 2 can cover the full width of the tread or only part thereof.

The number of pins 5 and their precise geometry are determined depending on the result desired in the finished tread. Each sector can have several pins or, on the contrary, some sectors can have no pins at all.

It is also possible for the pins 5 to be mounted on shoulder sectors that can move radially, as described in the document EP 1 232 852.

Pins can be arranged axially or in a direction oblique to the tire's axis. Moreover, the radial cross-section of at least one pin can vary along the direction of the pin's largest dimension.

The molds according to the invention enable treads to be molded, which may or may not be annular and of finite length or, on the contrary, of quasi-infinite length, continuous and flat. In this way not only treads intended for the production or retreading of tires can be molded, but also rubber caterpillar tracks.

1- Mold for molding a tread made from a rubber mix, this tread having a running surface bounded axially by lateral faces, the mold comprising at least one part for molding the running surface, at least two lateral parts for molding the lateral faces and at least one pin for molding a cavity inside the tread, this pin, when viewed in a section plane perpendicular to the mold face that molds the running surface and to the axial direction, having a surface whose contour is formed by a first contour portion and a second contour portion, these contour portions extending between the contour point located closest to, and the contour point located furthest away from the mold face that molds the running surface, the pin being positioned at least partially below the face that molds the running surface and being connected to at least one mold face that molds at least part of a lateral face of the tread, such that during molding the pin produces two flows of the rubber mix which envelop the pin and reunite to form a junction surface, wherein at least one pin has means to render the mix flows asymmetrical so that the junction surface, viewed in the said plane, is such that the length of the trace of the junction surface on the plane, measured between the surface of the pin and the mold face that molds the running surface, is longer than the minimum distance between the surface of the pin and the face that molds the running surface.

2- Mold according to claim 1, wherein the length of the first contour portion is different from the length of the second contour portion.

3- Mold according to claim 2, wherein the difference between the length of the first contour portion and the length of the second contour portion is at least equal to 10% of the length of the shorter contour portion.

4- Mold according to claims 1, wherein one of the contour portions is provided with a mean surface roughness greater than the mean surface roughness of the other contour portion.

5- Mold according to claim 4, wherein the difference between the mean surface roughnesses Ra of the first contour portion and the second contour portion is at least equal to 2 microns.

6- Mold according to claim 1, wherein at least one contour portion is at least partly covered by a coating so as to produce a difference in the slip velocity of the mix on the contour portions.

7- Mold according to claim 1, wherein means are also provided for producing a mean temperature difference between the surface of the first contour portion and the surface of the second contour portion of at least one pin.

8- Mold according to claim 7, wherein the temperature difference is equal to at least 20° C.

9- Mold according to claim 1, wherein at least one pin for molding a cavity has additional means for causing it to rotate essentially about its longitudinal axis.

10- Mold according to claim 1, wherein at least one pin is mounted so that it can move axially and radially relative to the mold, such that it can undergo a translation movement in a plane forming an angle [symbol] smaller than 90° relative to a direction perpendicular to a radial direction.

11- Tread made from a rubber mix, this tread having a running surface bounded axially by lateral faces and comprising at least one cavity at least part of which is located below the running surface and which opens onto at least one lateral face of the tread, the tread being provided with a junction surface that extends between the surface of at least one cavity and the running surface, wherein the length of the trace of the junction surface in a section plane perpendicular to the running surface and to the axial direction, measured between the surface of the cavity and the running surface, is longer than the minimum distance between the surface of the cavity and the running surface.

12- Tread according to claim 11, wherein the difference between the length of the trace and the minimum distance between the surface of the cavity and the running surface is larger than 20% of the minimum distance.
